(19) United States
(12) Patent Application Publication
(10) Pub. No.: US 2016/0210250 A1
(43) Pub. Date: Jul. 21, 2016

(54) MOTHERBOARD WITH DUAL MEMORY SLOTS AND COMPUTER SYSTEM WITH THE SAME

(71) Applicant: ASUSTeK COMPUTER INC., Taipei (TW)

(72) Inventors: Li-Chien Wan, Taipei (TW); Hsin-Ting Chen, Taipei (TW); Jian-Tzuo Chen, Taipei (TW)

(21) Appl. No.: 14/991,282

(22) Filed: Jan. 8, 2016

(30) Foreign Application Priority Data
Jan. 15, 2015 (CN) 201510020123.6

(51) Int. Cl. G06F 13/16; G06F 13/42; G06F 13/40

(52) U.S. Cl. CPC G06F 13/1668; G06F 13/4068; G06F 13/4282

(57) ABSTRACT

A motherboard with dual memory slot is disclosed. The motherboard includes multiple first memory slots, multiple second memory slots, a storage unit, and a CPU. The first and second memory slots are used for connecting with memory modules of different specifications. A storage unit stores BIOS which identifies the specification of the memory module in booting, and the identification result is provided to the CPU. Consequently, the memory controller in the CPU controls the reading and writing to the memory module according the determining result of the BIOS. As a result, a single motherboard supports memory modules of different specifications, and the flexibility of using the memory modules is improved.

### CROSS-REFERENCE TO RELATED APPLICATION

This application claims the priority benefit of China application serial No. 201510020123.6, filed on Jan. 15, 2015. The entirety of the above-mentioned patent application is hereby incorporated by references herein and made a part of specification.

### BACKGROUND OF THE INVENTION

1. Field of the Invention

The invention relates to a motherboard and, more particularly, relates to a motherboard and its computer system

2. Description of the Related Art

Most conventional motherboards only support memories with single specification, such as a Double Data Rate (DDR) memory.

However, memories with varies new specifications are launched and developed to improve the reading and writing speed, operation voltage, and reduce operation temperature and the cost. Users are now facing whether to update the old memories with old specifications or to purchase a new one. Moreover, when new memory with a new specification is utilized, a new motherboard which supports new specification is also required. Thus, the cost gets higher when user chooses to use new memories.

On the contrary, if a motherboard that equipped with a memory slot that complying an old specification is replaced by a new motherboard, the memory slot on the new motherboard maybe comply to a new specification which cannot support an original memory module, and then the old memory module also needs to be replaced to comply a new specification.

### BRIEF SUMMARY OF THE INVENTION

According to a first aspect of the present disclosure, a motherboard with dual memory slot, applied with a central processing unit (CPU) including a memory controller, the motherboard comprises: a plurality of first memory slots for connecting with a plurality of first memory modules and coupling to the CPU; a plurality of second memory slots for connecting with a plurality of second memory modules and coupling to the CPU; and a storage unit storing BIOS and coupling to the CPU, wherein the BIOS reads Serial Presence detect (SPD) stored in a memory module at the first memory slot or the second memory slot and generates a determining result representing whether the memory module complies to a first specification or a second specification, wherein the first memory module complies to the first specification, and the second memory module complies to the second specification; wherein the memory controller of the CPU controls reading and writing to the first memory module or the second memory module according the determining result of the BIOS.

According to a second aspect of the present disclosure, a computer system is further disclosed herein. The computer system comprises: a central processing unit (CPU) including a memory controller; and a motherboard with dual memory slots, including: a plurality of first memory slots for connecting with a plurality of first memory modules; a plurality of second memory slots for connecting with a plurality of second memory modules; and a storage unit storing BIOS, wherein the BIOS reads SPD stored in a memory module at the first memory slot or the second memory slot and generates a determining result representing whether the memory module complies a first specification or a second specification, wherein the first memory module complies to the first specification, and the second memory module complies to the second specification, wherein the CPU connected to the first memory slot, the second memory slot and the storage unit, and the memory controller controls reading and writing to the memory module according the determining result of the BIOS.

The motherboard in embodiments at least supports the memory module of two deferent specifications. The BIOS reads the SPD of the memory module to determine the speciation of the current memory module, and then the memory controller controls the reading and writing to the memory module. As a result, an original memory module can be kept when a motherboard is updated and replaced, and an original motherboard also can be kept when a memory is updated and replaced, and the memory of a new speciation is inserted to a corresponding memory slot.

A computer system including a motherboard with dual memory slots is provided. The motherboard with the dual memory slots includes a plurality of first memory slots, a plurality of second memory slots, a storage unit, and a CPU. The first memory slots are used for connecting with a plurality of the first memory modules. The second memory slots are used for connecting with a plurality of second memory modules. A storage unit stores BIOS, the BIOS reads SPD stored in a memory module of the first memory modules or the second memory modules to determine the memory module is first specification or second specification. The first memory module is the first specification, and the second memory module is the second specification. The CPU includes a memory controller and is connected to the first memory slot, the second memory slot and the motherboard firmware. The memory controller controls reading and writing to the memory module according the determining result of the BIOS.

### BRIEF DESCRIPTION OF THE DRAWINGS

These and other features, aspects and advantages of the invention will become better understood with regard to the following embodiments and accompanying drawings.

FIG. 1 is a schematic diagram showing a motherboard supporting memories of dual specifications in an embodiment;

FIG. 2 is a schematic diagram showing that a memory module is inserted to a motherboard in an embodiment; and

FIG. 3 is a schematic diagram showing a computer system.

### DETAILED DESCRIPTION OF THE EMBODIMENTS

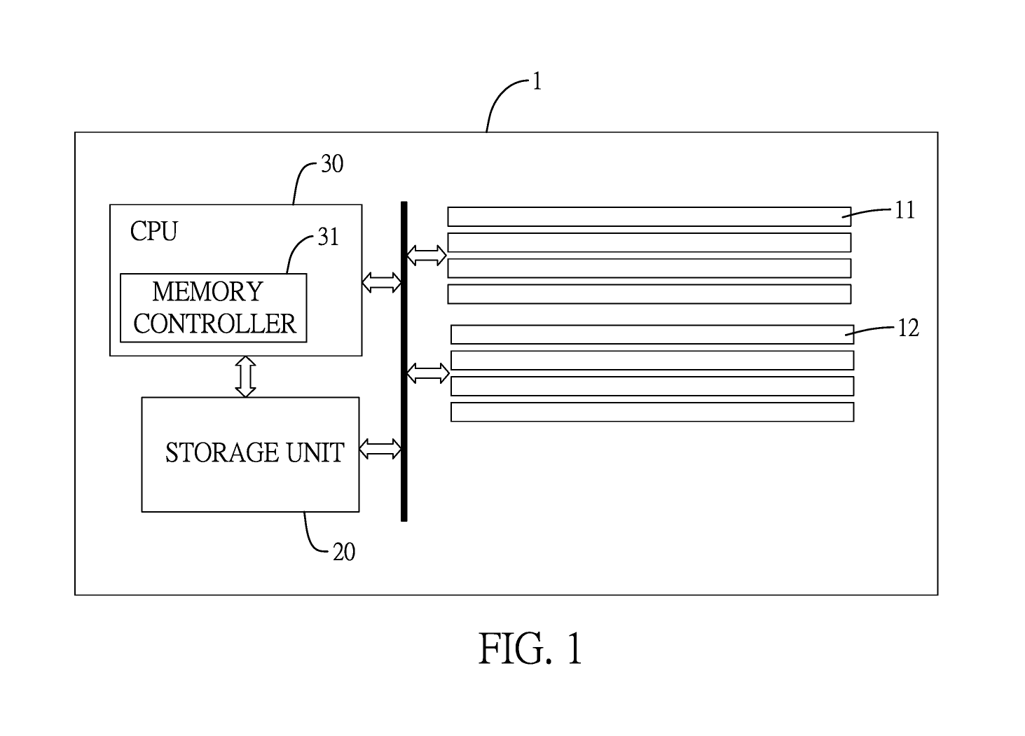

As shown in FIG. 1, a motherboard 1 with dual memory slots includes a plurality of first memory slot 11, a plurality of second memory slot 12, a storage unit 20 and a Central Processing Unit 30 (CPU). Many components are omitted in FIG. 1 for a concise purpose. The first memory slots 11 allow for a plurality of first memory modules inserted thereto. Each of the first memory modules complies to a first specification. In the embodiment, the number of the first memory slots 11 is four. The second memory slots 12 allow the second memory modules connected thereto. Each of the second memory modules complies to the second specification. In the embodiment, the number of the second memory slot 12 is four. In the embodiment, the first memory modules and the second memory modules are DDR3 and DDR4 specifications, respectively. As a result, the first memory slot 11 supports a DDR3 memory module, and the second memory slot 12 supports a DDR4 memory module.

The shape and the size of the DDR3 memory module and those of DDR4 memory module are different, and thus the memory module would not be inserted to an un-corresponding slot by mistake.

In an embodiment, the storage unit 20 is an Electrically-Erasable Programmable Read-Only Memory (EEPROM) or a flash memory, which is not limited herein. The storage unit 20 stores BIOS (basic input/output system, so-called BIOS hereinafter) which is executed when a computer system boots. The BIOS automatically identifies the current operation states of the first memory slot 11 and the second memory slot 12 to determine to assign the first memory modules or the second memory modules, the detail of the identification process is illustrated hereinafter.

The CPU 30 includes a memory controller 31 built therein. The CPU 30 is connected to the first memory slot 11 and the second memory slot 12. When the BIOS identifies the memory module, an identification result is provided to the CPU 30 to control the memory controller 31 to read or write to a assigned DDR3 or DDR4 memory module in a corresponding control way.

The identification process executed by the BIOS is in the booting process. The identification process in an embodiment is illustrated hereinafter. Regardless of the memory module is the DDR3 memory module or a DDR4 memory module, the SPD is pre-stored therein. The SPD is recorded in an EEPROM. The SPD includes the identification information such as capacity of memory particles, speed, manufacturer, operation voltage. Consequently, the memory module is DDR3 speciation or DDR4 speciation is directly determined according to the SPD.

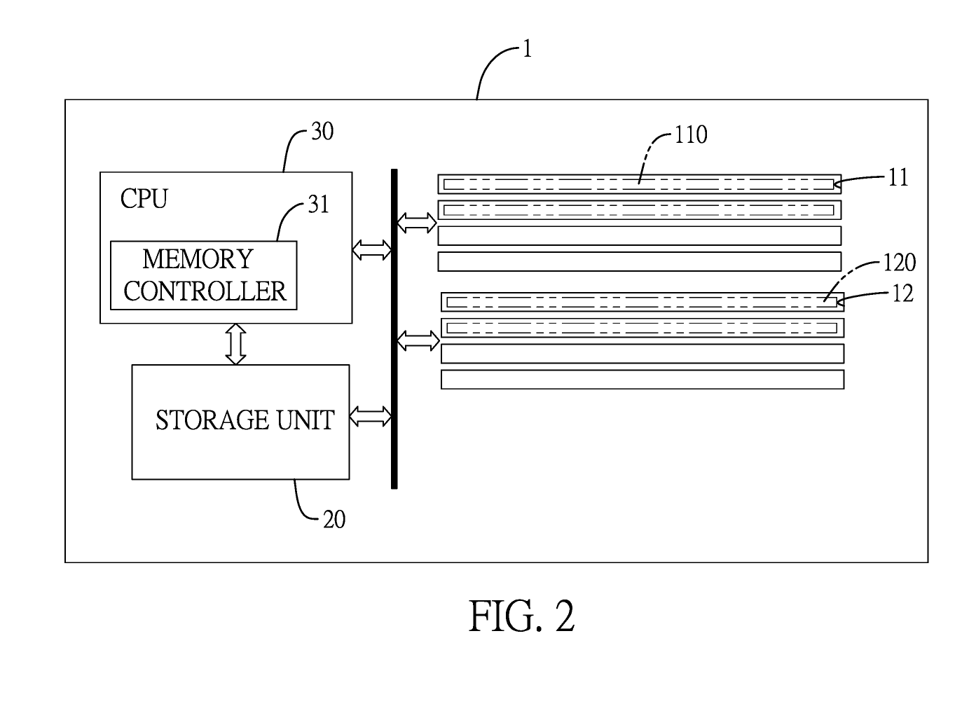

As shown in FIG. 2, when only DDR3 memory module 110 is inserted to the first memory slot 11 or when only the DDR4 memory module 120 is inserted to the second memory slot 12, the BIOS determines whether the first memory slot 11 is connected with the memory module 110 or the second memory slot 12 is connected with the memory module 120. If the first memory slot 11 is connected with the memory module 110 or if the second memory slot 12 is connected with the memory module 120, the BIOS reads the SPD of the memory module 110 or 120 to determine the memory module is DDR3 or DDR4 speciation, and the identification result is provided to the CPU 30. Then, the memory controller 31 is able to access data to the DDR3 memory module 110 or the DDR4 memory module 120.

When the DDR3 memory module 110 is inserted to the first memory slot 11 and the DDR4 memory module 120 is inserted to the second memory slot 12, respectively, the BIOS assigns one of the first memory slot 11 and the second memory slot 12 according to the preset parameter. In an embodiment, the BIOS only assigns the DDR4 memory module 120 in the second memory slot 12, and the assigning result is provided to the CPU 30, and then the memory controller 31 is able to access data to the DDR4 memory module 120, and the computer boots normally.

In the above embodiment, the memory slots of two different specifications are provided at a same motherboard. Consequently, an original memory module can be kept when a motherboard is updated and replaced, and an original motherboard also can be kept when a memory is updated and replaced, and the memory of a new speciation is inserted to a corresponding memory slot. As a result, consumers have more choices, and the components can be used longer.

In an embodiment, the memory controller 31 is integrated in the CPU 30, that is, the memory controller 31 is not an independent control chip (such as a north bridge chip) connected to the CPU via external lines. As a result, the stability of the memory controller 31 in accessing data to the memory module is improved without affected by an unstable environment.

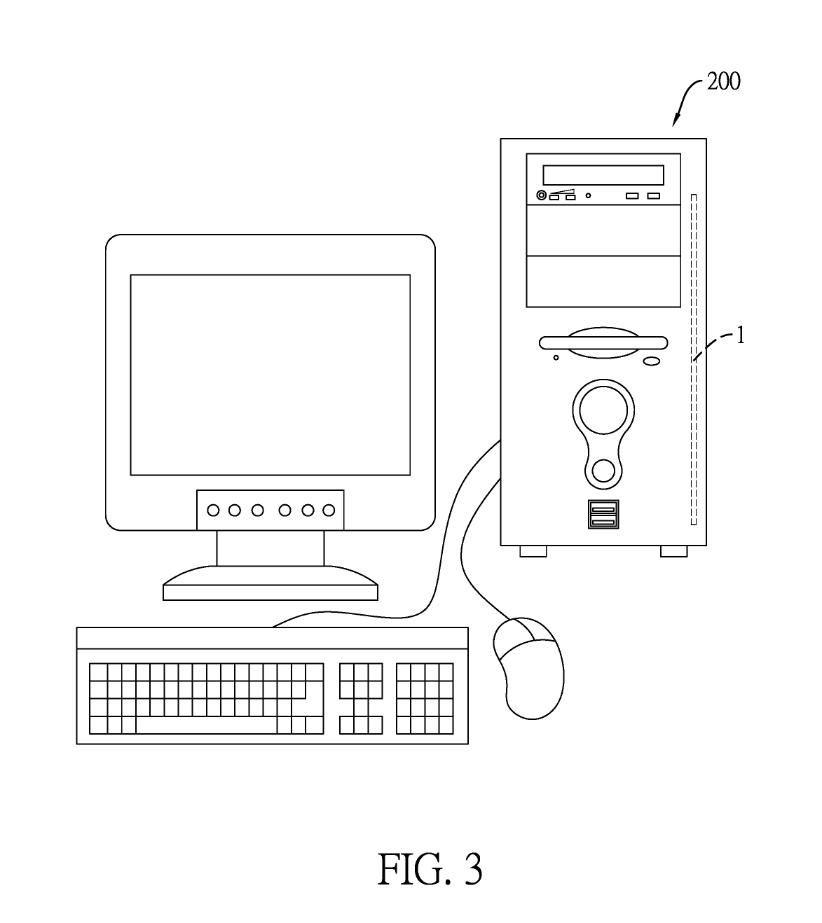

A computer system 200 in an embodiment is as provided in FIG. 3. In an embodiment, the computer system is a personal computer, an industrial computer, or other electronic devices with a processing function. In an embodiment, the motherboard with dual memory slots 1 is used to control operations of the computer system with other peripheral devices.

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. A motherboard with dual memory slot, applied with a central processing unit (CPU) including a memory controller, the motherboard comprising:
a plurality of first memory slots for connecting with a plurality of first memory modules and coupling to the CPU;
a plurality of second memory slots for connecting with a plurality of second memory modules and coupling to the CPU; and
a storage unit storing BIOS and coupling to the CPU, wherein the BIOS reads Serial Presence detect (SPD) stored in a memory module at the first memory slot or the second memory slot and generates a determining result representing whether the memory module complies to a first specification or a second specification, wherein the first memory module complies to the first specification, and the second memory module complies to the second specification;
wherein the memory controller of the CPU controls reading and writing to the first memory module or the second memory module according the determining result of the BIOS.

2. The motherboard with dual memory slots according to claim 1, wherein the first specification is DDR3 and the second specification is DDR4.

3. The motherboard with the dual memory slots according to claim 1, wherein the storage unit is an Electrically Erasable Programmable Read-Only Memory (EEPROM) or a flash memory.

4. The motherboard with dual memory slots according to claim 1, wherein when the first memory slot is connected to the first memory modules, or when the second memory slot is connected to the second memory modules, the BIOS determines which of the first memory modules or the second memory modules is connected, and the BIOS provides the determining result to the memory controller.

5. The motherboard with dual memory slots according to claim 1, wherein when the first memory slot is connected to the first memory module and the second memory slot is connected to the second memory module, respectively, the BIOS provides the determining result to the memory controller to assign the second memory module with the second specification according to a preset parameter.

6. A computer system, comprising:
a central processing unit (CPU) including a memory controller; and
a motherboard with dual memory slots, including:
a plurality of first memory slots for connecting with a plurality of first memory modules;
a plurality of second memory slots for connecting with a plurality of second memory modules; and
a storage unit storing BIOS, wherein the BIOS reads SPD stored in a memory module at the first memory slot or the second memory slot and generates a determining result representing whether the memory module complies a first specification or a second specification, wherein the first memory module complies to the first specification, and the second memory module complies to the second specification,
wherein the CPU connected to the first memory slot, the second memory slot and the storage unit, and the memory controller controls reading and writing to the memory module according the determining result of the BIOS.

7. A computer system according to claim 6, wherein the first specification is DDR3 and the second specification is DDR4.

8. A computer system according to claim 6, wherein the storage unit is an EEPROM or a flash memory.

9. A computer system according to claim 6, wherein when the first memory slot is connected with the first memory modules, or when the second memory slot is connected with the second memory modules, the BIOS determines which of the first memory module and the second memory module is connected, and BIOS provides the determining result to the memory controller.

10. A computer system according to claim 6, wherein when the first memory slot is connected with the first memory module and the second memory slot is connected with the second memory module, respectively, the BIOS provides the determining result to the memory controller to assign the memory module with the second specification according to a preset parameter.
